(19) United States
(12) Patent Application Publication
(10) Pub. No.: US 2012/0040326 A1
(43) Pub. Date: Feb. 16, 2012

(54) METHODS AND SYSTEMS FOR OPTIMIZING INDIVIDUALIZED INSTRUCTION AND ASSESSMENT

(76) Inventors: Emily Larson-Rutter, Bellingham, WA (US); John William Larson Rutter, Bellingham, WA (US)

(21) Appl. No.: 13/207,797

(22) Filed: Aug. 11, 2011

Related U.S. Application Data
(60) Provisional application No. 61/373,001, filed on Aug. 12, 2010.

(51) Int. Cl. G09B 5/00

(52) U.S. Cl. 434/350

(57) ABSTRACT

This application provides methods and systems for optimizing individualized instruction and assessment. In one embodiment a system for optimizing individualized instruction and assessment is provided. The system includes a user base component, a knowledge base component, a standards base component and an inference engine module. The user base component contains an electronic student record data for an individual. The knowledge base component contains knowledge management data. The standards base component contains curriculum data and criteria data. The inference engine module uses the electronic student record of the individual, knowledge management data and curriculum data and criteria data to create an individualized lesson plan for the individual.

### PRIORITY DATA

This application claims the benefit of U.S. Provisional Patent Application Ser. No. 61/373,001 entitled “METHODS AND SYSTEMS FOR OPTIMIZING INDIVIDUALIZED INSTRUCTION AND ASSESSMENT,” filed on Aug. 12, 2010, which is incorporated by reference in its entirety.

### FIELD

This disclosure relates to methods and systems for optimizing individualized instruction and assessment.

### BACKGROUND

An essential part of the education system is meeting each student's individual educational/learning needs. Individuals learn differently based on their personality makeup. For example, in a classroom setting, a teacher will typically use a variety of instructional strategies to teach a concept in the hope that one of these strategies will match with each student's learning style. However, due to time constraints, when a student is having difficulty in understanding the concept it becomes difficult for a teacher to focus his/her attention to help the student to understand the troublesome skill/concept. Thus, to assess the progress of the students and to progress in the curriculum, the teacher administers a test that is graded and recorded. After the test, the teacher then moves on to teach the next portion of the curriculum. However, test results may not pinpoint gaps in the student's learning or provide analysis for the student's progress.

Moreover, spending time to teach a concept using a variety of instructional strategies can also be a detriment for the students. For example, spending time to teach the skill/concept using several instructional strategies can lead to boredom and inattention to those students who grasped the concept/skill when the teacher used the first instructional strategy. This can also cause frustration for the students who do not understand this strategy.

Formal assessment and documentation of individual learning styles is not routinely done, so it is left to individual teachers to determine informally. For example, one student may learn best through auditory means, while another student needs to read and write the concept/skill to understand it, and yet another student may learn best through manipulating three-dimensional objects. Thus, it is difficult to systematically tailor a curriculum to address the different learning styles of different students.

With generally high student to teacher ratios, limited allotment of instruction time per subject, and a wide range of skill levels and learning styles amongst students in a classroom, it is difficult for teachers to effectively instruct his/her students both efficiently and effectively.

### SUMMARY

This application provides methods and systems for optimizing individualized instruction and assessment. The embodiments described herein can be employed within a variety of different frameworks including, for example, an academic/education framework, a business training/development framework, and a customized web experience framework.

For example, in one embodiment, the methods and systems provided herein allow a student to have access to highly individualized instruction and assessment that is based on the student's learning style and previous performance. Personality and performance data is continuously compiled in an electronic student record. The methods and systems could provide a stand-alone teaching and assessment system or supplement current classroom curriculum.

In another embodiment, the methods and systems described herein allow a business to identify an ideal personality type for each job position; allow a business to compile employee performance data including, for example, working times and hours, work accuracy, speed and quantity, and personality types to choose who to promote; and allow a business to provide personalized interactive training for employees.

In yet another embodiment, the methods and systems described herein provide customized web experiences to users, for example, by collecting personality data of a user to identify personality types. The personality data on a user can be used to, for example, strip data from web sites and represent the stripped data according to the user's needs, and provide customized formats, colors, layouts, etc., to the user. The customized web experiences described herein can be controlled by the user via a user control panel or automatically controlled. The customized web experiences can be applied to target market products and services according to basic personality types as opposed to search and browsing history.

In yet another embodiment, the methods and systems described herein provide a music education where a student's playing of various instruments is recorded as electronic data, various ways to teach according to the student's need are provided, and the student's performance is compared to standard requirements.

In yet another embodiment, a system for optimizing individualized instruction and assessment, includes: a user base component that contains electronic student record (ESR) data for an individual; a knowledge base component that contains knowledge management data; a standards base component that contains curriculum data and criteria data; a network connecting the user base component, the knowledge base component and the standards base component; an inference engine module that can access to the ESR data of the user base component, the knowledge management data of the knowledge base component, and the curriculum data and criteria data of the standards base component, and creates an individualized lesson plan for the individual based on the data therein; and a communication terminal for the individual to interact with the inference engine module.

In yet another embodiment, a method for optimizing individualized instruction and assessment, includes: monitoring and detecting an individual to login into an individualized instruction and assessment system which includes a user base component, a knowledge base component and a standards base component; transforming electronic student record (ESR) data for the individual into formatted ESR data; accessing knowledge management data provided by the knowledge base component and curriculum and criteria data provided by the standards base component, and processing the ESR data with the knowledge management data and the curriculum and criteria data; and determining whether the formatted ESR data is sufficient to create an individualized lesson plan. If the formatted ESR data is not sufficient, performing an additional assessment on the individual and updating the formatted ESR data until the formatted ESR data is sufficient to create an individualized lesson plan. If the formatted ESR is sufficient, creating the individualized lesson plan for the individual, including: determining curriculum and criteria data sets for creating the lesson plan; accessing the knowledge management data and determining a psychological data set, a brainwave data set, a language/cultural data set, an instruction data set and a performance data set for creating the lesson plan; and compiling the curriculum and criteria data set, the psychological data sets, the brainwave data set, the language/cultural data set, the instruction data set and the performance data set to create the lesson plan; and presenting the individualized lesson plan to the individual.

In yet another embodiment, a method is for providing a graphical user interface to a computer device for an individual to answer one or more questions and to evaluate the individual's answer. The method includes: creating question and answer drills based on state and national academic standards; displaying on a display of the computer device a first question from the question and answer drills; monitoring and detecting the individual's answer; determining whether the individual's answer is correct; and analyzing the individual's incorrect answer. Analyzing the individual's incorrect answer, includes: determining whether the incorrect answer is a result of the individual making a wild guess; sending out an alert to the individual if the individual made the wild guess; and determining one or more causes associated with why the individual could have reached the incorrect answer. If there are multiple causes, presenting the individual a second question that is configured to narrow down the number of the multiple ways. If there is only one cause, recording the cause in a formatted ESR data and providing a step by step tutorial to the individual based on the cause. Producing an assessment report and displaying the report on the display.

In yet another embodiment, a method if for providing a graphical user interface to a computer device for an individual to exercise a plurality of mathematical expressions including a first mathematical expression step by step and to evaluate the individual's performance. The method includes: displaying on a display of the computer device the mathematical expression; and monitoring and detecting for selection of a first operator associated with a first operation in the first mathematical expression; after detecting the selection of the first operator, displaying on the display of the computer device an input box for the individual to input an answer to the first operation; monitoring and detection for the individual's input; displaying an updated mathematical expression with the first operation of the first mathematical expression replaced by the individual's input; after detecting a final answer for the mathematical expression, evaluating the individual's selection of the first operator and evaluating the individual's answer to the selected first operation; and displaying a result associated with the evaluations on the display of the computer device.

### DRAWINGS

FIG. 1 illustrates a high-level block diagram of an individualized instruction and assessment system.

FIG. 2 (a) shows a block diagram of one configuration of a user base component.

FIG. 2 (b) shows a block diagram of one configuration of a standards base component.

FIG. 2 (c) shows a block diagram of one configuration of a knowledge base component.

FIG. 2 (d) shows a block diagram of one configuration of a termination terminal.

FIG. 3 illustrates a flowchart for providing an exemplary method of individualized instruction and assessment.

FIG. 4 provides a flowchart for providing an exemplary method of how the exercise/evaluation section is performed.

FIG. 5 illustrates a flowchart for providing an exemplary method to analyze an incorrect answer.

FIG. 6 shows a block diagram of an operation module included in a standards base component or a user base component, according to one embodiment.

FIG. 7 shows an example screenshot of an exemplary graphical user interface (GUI), according to one embodiment.

FIG. 8 shows another example screenshot of an exemplary GUI, according to one embodiment.

FIG. 9 shows an exemplary JSON coding for providing a step-by-step evaluation of a user's answer to a mathematical exercise, according to one embodiment.

FIG. 10 shows an example screenshot of an exemplary accumulative evaluation report of a user, according to one embodiment.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice what is claimed, and it is to be understood that other embodiments may be utilized without departing from the spirit and scope of the claims. The following detailed description is, therefore, not to be taken in a limiting sense.

The embodiments described herein are directed to systems and methods for optimizing individualized instruction and assessment within an academic/education framework. In the embodiments described below, the systems and methods described herein allow a student to have access to highly individualized instruction and assessment that is based on the student's learning style and previous performance. However, the embodiments described herein can also be used within a variety of other frameworks, including for example, a business training/development framework, a customized web experience framework, a music education framework, etc.

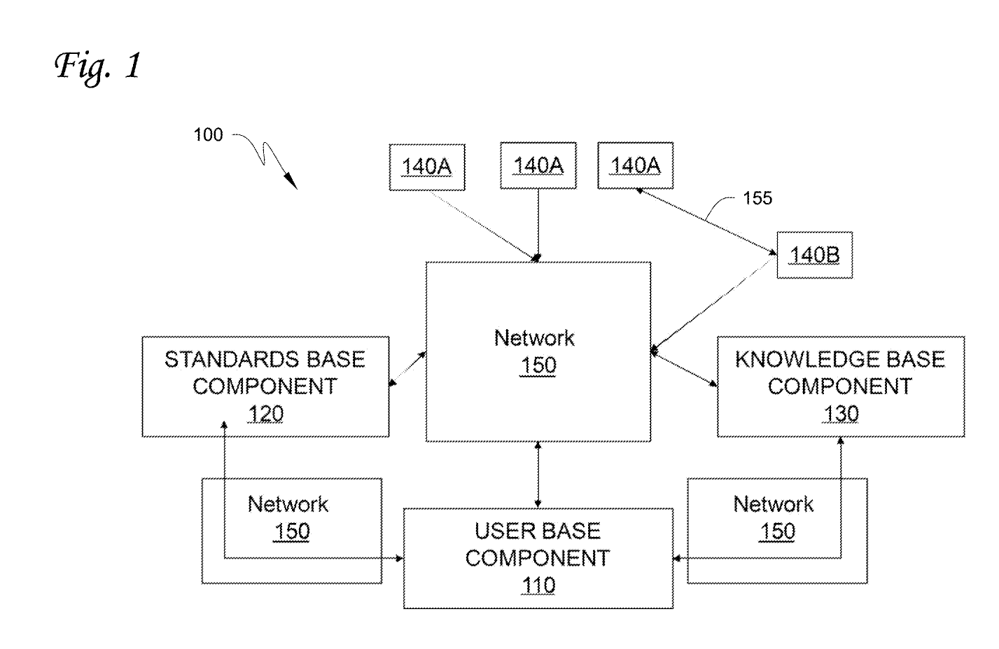

FIG. 1 illustrates a high-level block diagram of an individualized instruction and assessment system 100, according to one embodiment. The system 100 creates math lesson plans for an individual that are tailored to the individual's unique learning style. As the individual progresses through a lesson plan, the system 100 collects concept data and learning style data. Concept data tracks how well the individual is learning the concepts taught in the particular lesson plan. Learning style data tracks which learning styles work best for the individual to learn most efficiently. As the individual progresses through multiple math lesson plans that build upon the concepts taught in previous math lesson plans, the system 100 uses the collected concept data and the collected learning style data to create individualized math lesson plans that are tailored to the individual's identified strengths and weaknesses with respect to concepts taught in previous math lesson plans and to the individual's individual learning style. Thus, the individual's learning progresses at a faster pace with higher quality outcomes.

The system 100 includes a user base component 110, a standards base component 120, a knowledge base component 130 and a plurality of communication terminals (140A-B). The standards base component 120 and the knowledge base component 130 are connected to the user base component 110 via a network 150.

In another embodiment, the user base component 110, the standards base component 120 and the knowledge base component 130 can also be disposed on a device (not shown) that connects to the network 150.

The user base component 110 acts as a central location for optimizing individualized academic instruction and assessment via an inference engine module, described in more detail below. The user base component 110 also stores individual student data, e.g. Electronic Student Record (ESR) data that includes individual personality data and knowledge data, described in more detail below.

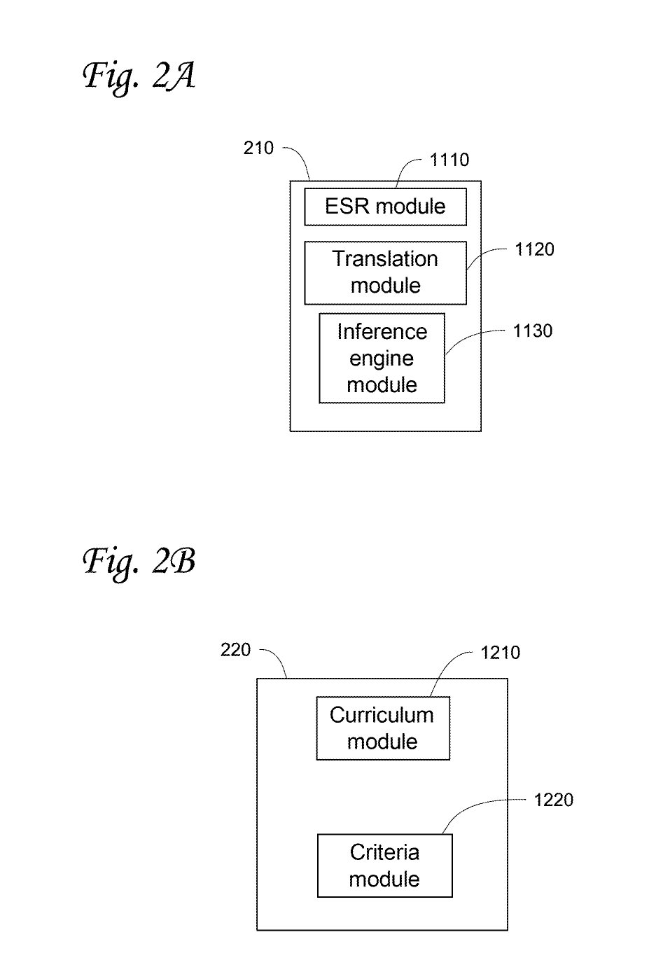

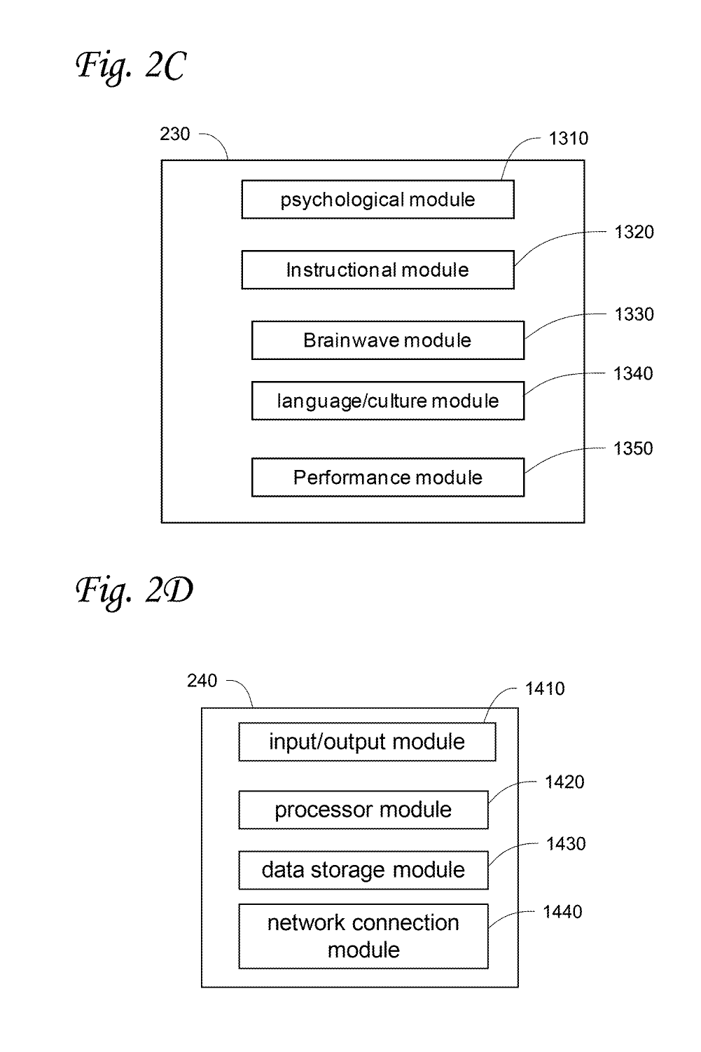

FIG. 2(a) is a block diagram of a user base component 210 according to one embodiment. The user base component 210 includes an electronic student record (ESR) module 1110, a translation module 1120 and an inference engine module 1130.

The ESR module 1110 stores ESR data for a particular individual. The ESR data include a plurality of individualized student data, for example, personality data and user base data of the individual.

The personality data include, for example, information relating to the personality aspects and learning styles that are unique to the individual using the individualized instruction and assessment system. According to one embodiment, the personality data is obtained via standardized tests such as Wechsler Intelligence Scale for Children (WISC), Developmental Test of Visual Perception-Adolescent and Adult (DTVP-A), Test of Everyday Attention for Children (TEA-Ch), Conner's Continuous Performance Test II (CPT II), Wechsler Individual Achievement Test (WIAT), etc.

The user base data include, for example, curriculum data to be taught to the individual, curriculum data according to what is mastered by the individual, and performance data generated according to the criteria in a standards base component, such as the standards base component 120 in FIG. 1. The performance data include, for example, date and time data according to time required to complete assignments, formal and informal assessment results, elements that were re-taught and results from reassessment, and other metrics useful for developing teaching strategies and mapping individual performance. The user base data can be used to generate a knowledge map of the individual, identify gap areas, and create smart reports to be used for report cards, conference records and teacher guidance.

The ESR module 1110 can track data from different subject areas, such as Reading and Writing to help educators get a “big picture” view of the student's academic strengths and weaknesses. In one embodiment, the ESR module 1110 includes a suite of visualization tools such as, for example, charts and graphs, that allow the ESR data to be displayed graphically to show student progress versus standard requirements.

In the embodiment of FIG. 2(a), the ESR module 1110 updates the individual's ESR data continually as new data is generated by the individual.

The translation module 1120 transforms the ESR data of the individual to allow the inference engine module 1130 to process the ESR data with ontology data provided by a knowledge base component and curriculum and criteria data provided by a standards base component.

The inference engine module 1130 uses ESR data stored in the user base component 210, knowledge management data provided by a knowledge base component, and curriculum and criteria data provided by a standards base component to create individualized instruction and formal and informal assessment for the individual. Formal assessments can include, for example, graded materials such as quizzes, exams, or oral questioning. Informal assessments can include, for example, practice exercises (homework, in class work, group work, etc.)

While in this embodiment, the inference engine module 1130 and the translation module 1120 are hosted by the user base component 210, in other embodiments, the inference engine module 1130 and the translation module 1120 are hosted by a standards base component (such as the standards base component 120 in FIG. 1), a knowledge base component (such as the knowledge base component 130 in FIG. 1), communication terminals (such as the communication terminals 140A-B in FIG. 1), a network (such as the network 150 in FIG. 1), or a website in Internet. In some embodiments, the inference engine module 1130 includes artificial intelligence technologies and neural network technologies so that the inference engine module 1130 adapts to the individual, as the individual continues to use the individualized instruction and assessment system.

Back to FIG. 1, the standards base component 120 stores benchmark data that includes curriculum data and criteria data to determine whether a student is meeting the standardized requirements. FIG. 2(b) illustrates a block diagram of a standards base component 220, according to one embodiment.

The standards base component 220 includes a curriculum module 1210 and a criteria module 1220. The curriculum module 1210 stores curriculum data that includes a specific progression of knowledge set data or building block data to be taught to the individual. The curriculum data also includes a plurality of basic concept data sets that combine later into more complex problem solving techniques.

The criteria module 1220 includes, for example, criteria data to measure student performance against the standards in the curriculum module 1210, to test for understanding of each concept, and to specify what level of understanding is satisfactory.

In academic terms, the criteria module 1220 provides the rubric for the standards base module 220.

In some embodiments, the curriculum data stored in the standards base component 220 is managed client side, for example, by an education field at a classroom, a school, a district, a state, or a national level, etc. The owner/administrator of an individualized instruction and assessment system (not shown in FIG. 2b) can edit the curriculum data to suit local needs, be they at the individual classroom level or a much broader level. The purpose of this feature is to allow national and state governments to set standards, and allow districts, schools, and classrooms the ability to specify how those standards are to be met and potentially go above and beyond those standards.

In other embodiments, the curriculum data stored in the standards base component 220 is managed by private companies including textbook companies, universities, technology companies, or information companies, etc. In these embodiments, the user buys or subscribes to the curriculum data stored in the curriculum module 1220.

Back to FIG. 1, the knowledge base component 130 stores knowledge management data that includes a plurality of rules data represented in a computational or algorithmic format. FIG. 2(c) provides a block diagram of a knowledge base component 230, according to one embodiment.

The knowledge base component 230 includes a psychological module 1310, an instructional module 1320, a brainwave module 1330, a language/culture module 1340, and a performance module 1350 that store particular types of the knowledge management data.

The psychological module 1310 provides a plurality of psychological data sets of the knowledge management data, including, for example, characteristics of mental attributes that affect learning, learning styles (such as visual, abstract, verbal, written, etc.), learning disorders (such as Attention-Deficit Hyperactivity Disorder and dyslexia), and best motivators and rewards for various defined individual types.

The instructional module 1320 provides a plurality of instructional data sets of the knowledge management data that provide different methodologies to present the same information, provide problem solving strategies and methods for solving a problem, and provide varying degrees of simplicity/sophistication for different age/capability groups. The instructional data sets are mapped to appropriate psychological data sets. For example, a personality type biased toward auditory learning would cause the instructional module 1320 to provide instructional strategies based on verbal presentation of concepts rather than written or pictorial strategies.

The brainwave module 1330 provides a plurality of brainwave data sets of the knowledge management data that include relationships between brain waves (alpha, beta, theta, etc.), learning types (short-term, long-term, computational, abstract, etc.), and methodologies for inducing specific brainwave activity (such as specific types of musical and visual stimuli, etc.)

The language/culture module 1340 provides a plurality of data sets of the knowledge management data that provide culture-specific translations to allow translation of the knowledge management data into various languages and culture norms in a natural fashion.

The performance module 1350 provides a plurality of performance data sets of the knowledge management data that identify common errors made by individuals. The performance module 1350 also maps the performance data sets provided in the performance module 1350 to the psychological data sets provided in the psychological module 1310 and identifies correlations between psychological profiles of individuals and common errors made by individuals. For example, a personality type biased toward attention deficit is more likely to make transcription errors (e.g., mixing up number order). The performance module 1350 also determines (in conjunction with a standards base component, such as the standards base component 120 in FIG. 1) what new material or review material is best for each individual based on the nature of the mistakes being made. For example, some mistakes might reveal a weakness in previously taught concepts.

Knowledge management data stored in the knowledge base component 230 is updated as new knowledge management data is obtained and validated. The new knowledge management data may include, for example, new psychological data sets that define how students with different personalities learn most effectively, new psychological data sets that define best practices for teaching students with different personalities, new instructional data sets that define ways to assess compliance to standards, new algorithms for the inference engine module, new brainwave data sets that define methods for effective brainwave warm-up, and most appropriate rewards, etc.

Back to FIG. 1, an individual, via the communication terminals 140A accesses an inference engine module, such as the inference engine module 1130 hosted by the user base component 210, via the network 150. The communication terminals 140A can be any type of device that accesses the network 150, such as a personal computer (PC, including a workstation, a desktop computer, an all-in-one PC, a laptop, a netbook, a tablet PC, a home theater PC, an ultra-mobile PC, a pocket PC, and many others), a smartphone (for example, iPhone), a personal digital assistance (PDA), etc.

A teacher, via the communication terminal 140B, accesses an inference engine module, such as the inference engine module 1130 hosted by the user base component 210, via the network 150. The communication terminal 140B is connected to the communication terminals 140A via the network 150 or a direct line 155. The communication terminal 140B allows the teacher to provide traditional instruction to and communication with the individual.

FIG. 2 (d) is a block diagram of a communication terminal 240 according to one embodiment. The communication terminal 240 can be a communication terminal such as one of the communication terminals 140A in FIG. 1 via which an individual accesses an inference engine module, or a communication terminal such as the communication terminal 140B in FIG. 1 via which a teacher accesses an inference engine module. The communication terminal 240 includes an input/output module 1410, a processor module 1420, a data storage module 1430, and a network connection module 1440.

An individual or a teacher sends/receives information through the input/output module 1410. The information is processed by the processor module 1420, is stored in the data storage module 1430, and communicates with a network, such as the network 150 in FIG. 1, via the network connection module 1440.

The input/output module 1410 may include, for example, voice input/output devices, full keyboard, stylus pen, touch screen capabilities, sound in/out and message capabilities, etc. The processor module 1420 processes information sent/received by the student or the teacher via the input/output module 1410.

The data storage module 1430 can be a remote data storage facility, a memory card, or any other known devices capable of storing information received from the input/output module 1410.

The network connection module 1440 can include, for example, a LAN connection at schools and WAN connections at home. However, in other embodiments other connection modules can be used.

In one embodiment, the communication terminal 240 is a compact, portable, wireless electronic device such as a Tablet PC, a Netbook, a Smart Phone, a standalone desktop or laptop computer. In some embodiments, the communication terminal 240 is located in a school computer lab where students can access an inference engine module, such as the inference engine module 1130 shown in FIG. 2(a) via the Internet.

In some embodiments, a school may provide the communication terminal 240 for each individual in the classroom. The communication terminal 240 is shared by the individuals in the classroom. In this embodiment, each individual accesses their ESR data, which is stored in an ESR module of a user base component, via a username and password.

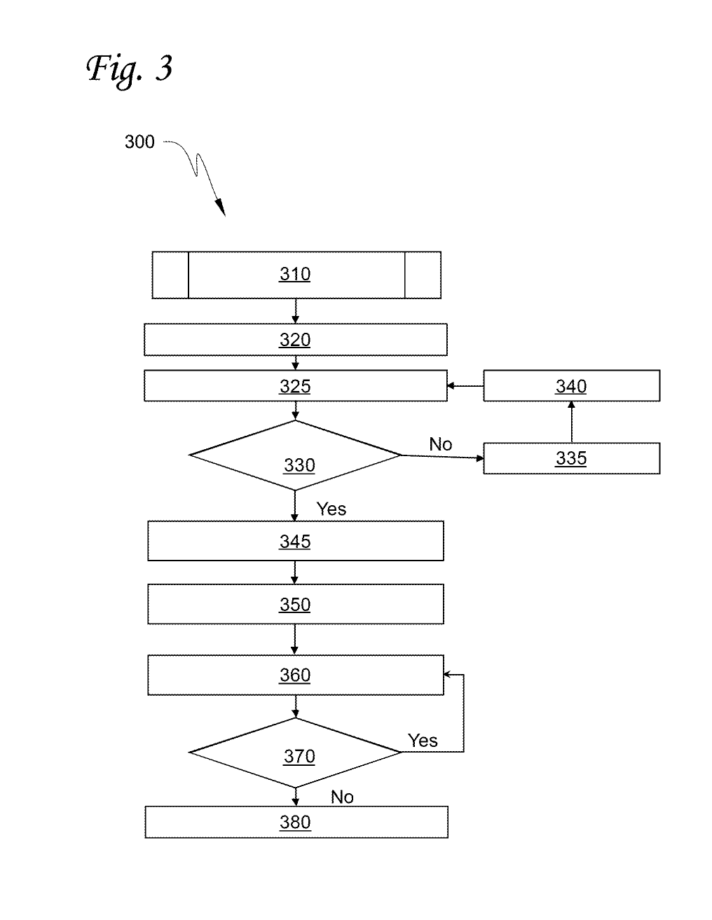

FIG. 3 is a flowchart 300 for providing a method of individualized instruction and assessment, according to one embodiment. The flowchart begins at step 310 where an inference engine module waits for an individual to access and login into an individualized instruction and assessment system, such as the individualized instruction and assessment system 100 in FIG. 1. The individual using a communication terminal, such as one of the communication terminals 140A in FIG. 1, accesses an individual base component, such as the user base component 210 in FIG. 2(a), via a network, such as the network 150 in FIG. 1. The flowchart 300 then proceeds to step 320.

At step 320, ESR data of the individual is transformed by a translation module, such as the translation module 1120 in the user base component 210 in FIG. 2(a), into formatted ESR data. The formatted ESR data allows an inference engine module to process the ESR data with knowledge management data provided by a knowledge base component and curriculum and criteria data provided by a standards base component. In that way an individualized lesson plan can be formed. The flowchart then proceeds to step 325.

At step 325, the inference engine module accesses the psychological module, the brainwave module and the language/cultural module from the knowledge base component and determines, based on the formatted ESR data, the appropriate psychological data sets, the appropriate brainwave data sets and the appropriate language/cultural data sets to use for creating the individualized lesson plan. The flowchart then proceeds to step 330.

At step 330, the inference engine module determines whether the formatted ESR data is sufficient to determine appropriate psychological, brainwave and language/cultural data sets to use for the lesson plan. If the formatted ESR data is sufficient, the flowchart proceeds to step 345. If the formatted ESR data is not sufficient, the flowchart proceeds to step 335.

At step 335, the inference engine module performs an additional assessment on the individual to add to the formatted ESR data. Depending on what data is missing, the additional assessment includes appropriate standardized test or exercise that is determined to fill in gaps. For example, a new individual might need to complete various skill level tests from the curriculum to determine existing knowledge, or a psychological test might be needed to determine learning style. The flowchart proceeds to step 340.

At step 340, the inference engine module updates the formatted ESR data of the individual. Once the formatted ESR data is updated, the flowchart then proceeds back to step 325.

At step 345, the inference engine module determines the appropriate curriculum data and criteria data for creating the individualized lesson plan. In some embodiments, the inference engine module accesses the standards base component and determines, based on the formatted ESR data, the appropriate curriculum data and criteria data for creating the individualized lesson plan. In other embodiments, the curriculum data and the criteria data is set by the teacher and obtained directly from a communication terminal, such as communication terminal 140B shown in FIG. 1. The flowchart then proceeds to step 350.

At step 350, the inference engine module accesses the instructional module and the performance module from the knowledge base component and determines, based on the formatted ESR data, the appropriate instructional data sets and the appropriate performance data sets to use for creating the individualized lesson plan. The flowchart then proceeds to step 360.

At step 360, the inference engine module uses all the data obtained in steps 325, 345 and 350 to compile and create the individualized lesson plan. The compiled lesson plan includes three sections: 1) the brain warm-up section; 2) the instruction section; and 3) the exercises/evaluation section.

The brain warm-up section includes warm-up exercises to maximize brainwave activity associated with learning the curriculum focused on in the individualized lesson plan. The warm-up exercises are created based on the appropriate curriculum data determined at step 345 and are individualized based on the appropriate psychological and brainwave data sets determined in conjunction with the formatted ESR data.

In one embodiment, the individualized lesson plan maximizes the brainwave activity by using specific auditory and visual cues such as music and light. In another embodiment, guided visualization is used to create confidence or otherwise prepare the individual for a successful learning experience. In yet another embodiment, a summary of the fundamental conceptual building blocks leading up to the current lesson is summarized to prepare the individual for learning new knowledge. In yet another embodiment, a game is played that uses the auditory and visual cues from the first example in a more subtle format disguised as a fun activity.

The instruction section includes the core presentation that is presented to the individual. The core presentation is created based on the appropriate curriculum data determined at step 345 and is individualized based on the appropriate psychological, instructional and language/cultural data sets determined in conjunction with the formatted ESR data.

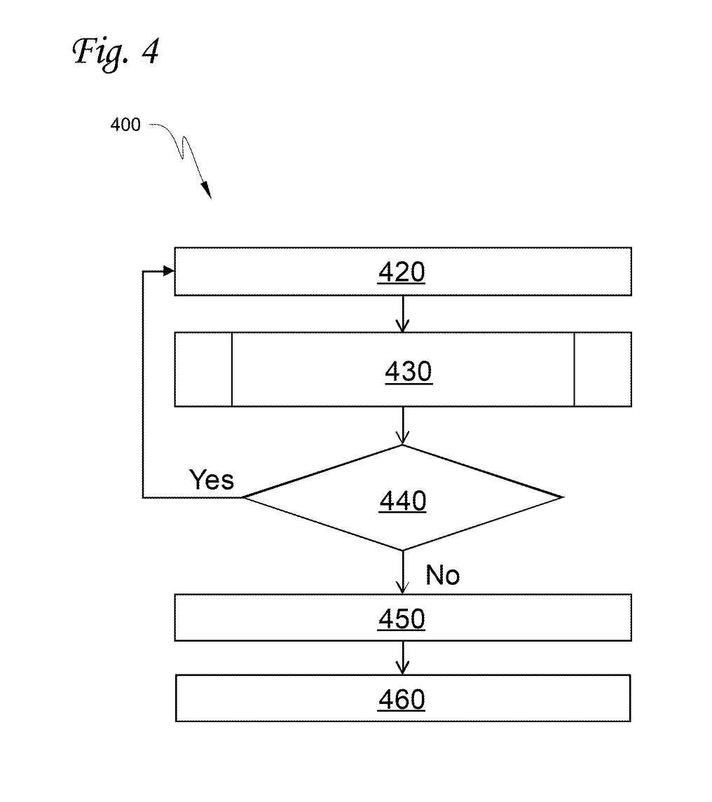

The exercise/evaluation section includes the question and answer drills that are presented to the individual to help the individual practice the concepts learned during the core presentation and to assess how well the individual has grasped the concepts learned during the core presentation. The drills are created based on the appropriate curriculum data determined at step 345 and are individualized based on the appropriate psychological and performance data sets determined in conjunction with the formatted ESR data. FIG. 4 provides a flowchart 400 of how the exercise/evaluation section is performed, according to one embodiment.

The flowchart 400 begins at step 420, where the inference engine module presents a question to the individual from the question and answer drills created by the inference engine module. The flowchart 400 then proceeds to step 430. At step 430, the inference engine module 430 waits for the individual to submit an answer to the question. The flow 400 then proceeds to step 440. At step 440, the inference engine module determines whether the individual's answer is correct. If the answer is correct, the flowchart 400 returns to step 420. If the answer is incorrect, the flowchart 400 proceeds to step 450.

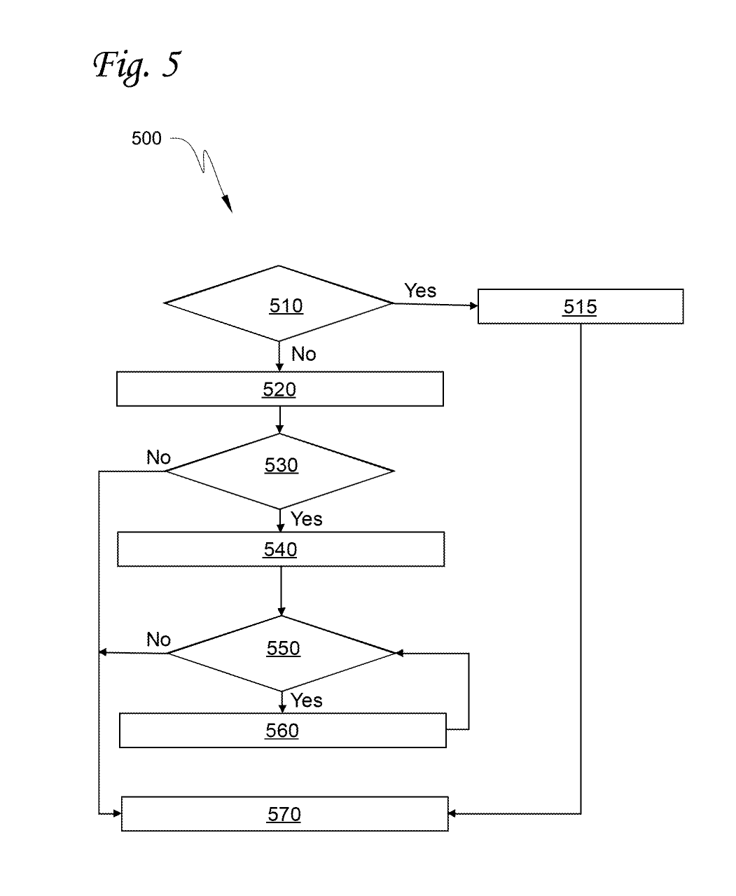

At step 450, the inference engine module analyzes the incorrect answer. In one embodiment, the inference engine module analyzes the incorrect answer to determine the cause of the wrong answer using the flowchart 500 provided in FIG. 5.

As shown in FIG. 5, the flowchart 500 begins at step 510 where the inference engine module determines whether the incorrect answer is the result of the individual making a wild guess. If the inference engine module determines that the individual provided a wild guess, the flowchart 500 proceeds to step 515. If the inference engine module determines that the individual did not provide a wild guess or is not certain whether the individual provided a wild guess, the flowchart proceeds to step 520.

At step 515, the interference engine module sends out an alert to the individual or a teacher via, for example, a communication terminal. The flowchart 500 then proceeds to step 570.

At step 520, the inference engine module determines each way the individual could have reached the incorrect answer. The flowchart then proceeds to step 530. At step 530, the inference engine module determines whether there is more than one way that the individual could have reached the incorrect answer. If the inference engine module determines that there is only one way that the individual could have reached the incorrect answer, the flowchart 500 proceeds to step 570. If the inference engine module determines that there could have been multiple ways that the individual could have reached the incorrect answer, the flowchart 500 proceeds to step 540.

At step 540, the interference engine module determines which way the individual most likely reached the incorrect answer based on the formatted ESR data of the individual. The flowchart 500 then proceeds to step 550 where the interference engine module determines whether there are multiple ways, based on the formatted ESR data of the individual, that the individual could likely have reached the wrong answer. If there still remain multiple ways that the individual could have reached the incorrect answer, the flowchart proceeds to step 560. If there remains only one way that the individual reached the incorrect answer, the flowchart 500 proceeds to step 570.

At step 560, the inference engine module presents the individual a second question that is used to narrow down the number of ways the individual could have achieved the incorrect answer. The flowchart the proceeds back to step 550.

At step 570, the interference engine module has determined the way the individual reached the incorrect answer and the inference engine module records the cause of the wrong answer in the formatted ESR data and the formatted ESR data is updated.

Returning back to FIG. 4, after the inference engine module determines the cause of the wrong answer to the question at step 450, the flowchart proceeds to step 460. At step 460, the inference engine module provides the individual with a step by step tutorial on how to solve specific type of problem. The step by step tutorial is created based on a core presentation (such as the core presentation at step 360 of FIG. 3) and is further individualized based on the cause of the wrong answer.

In another embodiment, after the inference engine module determines the cause of the wrong answer to the question at step 450, the inference engine module provides the individual a series of questions to answer and determine the cause(s) of wrong answer(s) using the same strategy illustrated in FIG. 5. Then the inference engine module provides the individual with a step by step tutorial on how to solve specific type of problem.

In yet another embodiment, after the inference engine module determines causes of wrong answers to a series of questions using the same strategy illustrated in FIG. 5, the inference engine module adapts the individualization strategy and re-teaches the lesson/concept in another way. For example, if the inference engine module determined, while creating the individualized lesson plan, that the individual's primary instructional strategy is based on an oral presentation of concepts and the individual's secondary instructional strategy is based on a visual presentation of concepts, the inference engine module could re-teach the concepts using the secondary instructional strategy.

Returning back to FIG. 3, at step 370, the individual is asked by the inference engine module whether to continue the lesson or not. If yes, the flow chart 300 proceeds back to step 360. If no, the flow chart 300 proceeds to step 380. In some embodiments, the inference engine can automatically continue if there are additional steps required by a preset lesson plan or test, or continue indefinitely.

At step 380, the formatted ESR data of the individual is updated and stored in an ESR module, such as ESR module 1110 in FIG. 2A, and an assessment report of the individual's progress using the individualized lesson plan is produced for the individual.

In another embodiment, a graphical user interface (GUI) is provided on a communication terminal with a display, such as the communication terminal 240, for a teacher and/or a student to login into, e.g., a specific website displayed on the display of the communication terminal. The specific website could be created based on, for example, state and national academic standards, or individualized standards according to specific academic goals. The website provides various exercises in any curriculum area for students. The exercises, for example, questions to be answered, are related to the standards that are expected to be met, for example, in a grade level associated with the state and national academic standards. On the website, a teacher could specify which standards should be worked on during a specific session. As the students work through the exercises, an algorithm, such as the inference engine module 1140, analyzes the student's data, for example, the student's answers to the questions, to determine whether a specific standard has been mastered. The algorithm also identifies problem areas for the student that prevents her/him from mastering that specific standard, e.g., a concept.

One example of the state and national academic standards is a specific 4^{th} grade Math standard as following. Standard 4.1.F: Fluently and accurately multiply up to a three-digit number by one- or two-digit numbers using the standard multiplication algorithm. For example, a graphical user interface is provided to ask a student to exercise a multiplication of 245×7 based on the above Standard 4.1.F on the specific website. If the student's answer to the question is incorrect, an algorithm, such as the inference engine module 1140, would analyze the student's answer and determine the source of this incorrect answer: for example, does the student have a problem with underlying concepts such as multiplication facts, place value, or carrying?

Once the student has finished the exercises, an individual assessment report would be generated based on that student's specific responses and be displayed on the website by the graphical user interface. The individual report would tell the teacher if there are any knowledge gaps or misunderstanding of concepts for the specific student.

A website based on a graphical user interface (GUI) can also be provided for a group of students who log onto the website as a class. In addition to individual reports, a group report for the group of students can be generated that informs the teacher of common errors that need re-teaching. Upon completion of an exercise, completion of multiple exercises, or upon exiting the website, a teacher would have information on what each individual student needs to work on as well as grouping information on students who have similar needs.

In one embodiment, when a student finishes a set of exercises, the website directs the student to a tutorial that can include, for example, sample questions to reteach any concepts that the algorithm determines the student needs to master further. In some embodiments, if the student has successfully mastered a concept by answering the questions in the exercises correctly, then the student can be directed to an advanced concept tutorial(s), an academic oriented game(s), etc.

In these embodiments, a GUI is provided that allows students and/or teachers to login onto a specific website in order to: target specific state/national standards; assist teachers and schools with raising test scores to comply with state and national standards; provide information for individual students on areas of misunderstanding within specific standards; provide root cause analysis of why a student has not mastered concepts; provide smart reports that detail areas of weakness for individuals as well as groups; etc.

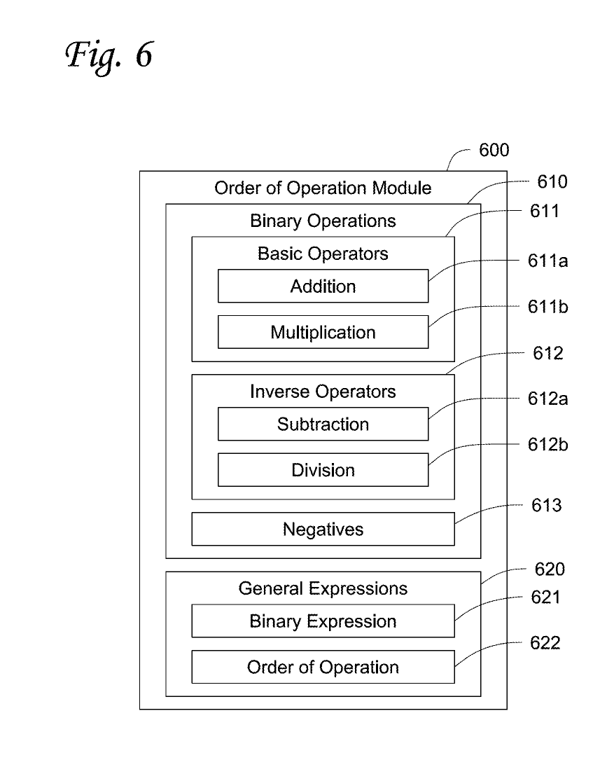

FIG. 6 is a block diagram for a presentation of an operation module which may be included in a standards base component or a user base component, such as the standards base component 220 and the user base 210. The operation module 600 includes sub-modules that should be mastered by a student to correctly understand and perform the goal of an instruction, i.e., to step-by-step evaluate a student's answer to a mathematical operation.

The operation module 600 includes a binary operations sub-module 610 which includes a basic operators sub-module 611, an inverse operators sub-module 612, and a negatives sub-module 613. The basic operator sub-module 611 includes two primary binary operators defined on the sets of integer, rational, and real numbers, i.e., addition operator 611a and multiplication operator 611b. Each binary operation results in a single output. The inverse operators sub-module 612 includes a subtraction operator 612a and a division operator 612b, which build on the addition operator 611a and the multiplication operator 611b by introducing the inverse of each operation. The inverse operators, i.e., the subtraction operator 612a and the division operator 612b, are not basic but can constitute new binary expressions through inversing the two basic binary operators, i.e., the addition operator 611a and multiplication operator 611b. The negatives sub-module 613 introduces a unary operator for negative numbers into the framework of binary expressions where the close association with the subtraction operator 612a is noted.

The operation module 600 further includes a general expressions sub-module 620 capable of building general expressions that are a series of binary expressions. The general expressions sub-module 620 includes a binary expression sub-module 621 and an order of operation sub-module 622. The binary expression sub-module 621 includes binary expressions which each include basic operators such as the addition operator 611a and the multiplication operator 611b, inverse operators such as the subtraction operator 612a and the division operator 612b, negative numbers, and/or their combinations.

The order of operations sub-module 622 introduces rules used to determine a cumulative evaluation of a binary expression built from binary expressions such as the binary expressions of the binary expression sub-module 621. Evaluation a general expression includes a series of steps, each of which evaluate a single binary or unary operation. Such evaluation is not inherently unique, being dependent on the order in which the individual binary operations are performed. The rules introduced in the order of operations sub-module 622 for general expressions are a set of conventions which form rules that, when, followed, will uniquely determine the evaluation of a general expression.

The critical determination of a student's understanding of the order of operations of a general expression, such as one created by the general expressions sub-module 620, cannot be distilled to a simple determination of the correct or incorrect final value of the general expression. An incorrect evaluation of the general expression could be from either the misapplication of the order of operation rules such as the rules of the order of operations sub-module 622, or from an incorrect evaluation of any of the binary operations such as one in binary expression sub-module 621, in the series of the binary expressions necessary to evaluate the general expression.

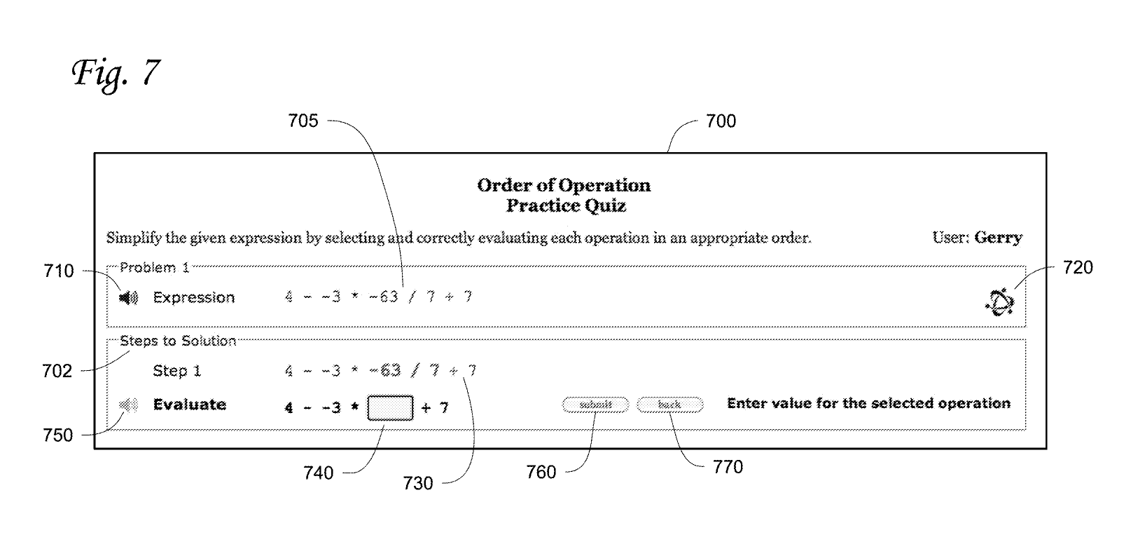

FIG. 7 illustrates an example screenshot of an exemplary GUI 700 that allows a user to perform a mathematical expression exercise via a step-by-step process. The exemplary GUI 700 displays an exemplary mathematical expression 705 generated by a general expressions sub-module of an operation module, such as the general expressions sub-module 620 of FIG. 6. The expression 705 includes, for example, five operands: 4, −3, −63, 7 and 7, and four operators: −, ×, /, and + connecting the operands sequentially.

An audio option 710 adjacent the expression 705 allows the user, for example, an auditory learner, to choose to hear an audio recording of the expression 705 and/or any other relevant information.

A model option 720 adjacent the expression 705 allows the user, for example, a visual learner, to choose to view the expression 705 and/or any other relevant information in a pictorial, video or model format.

The GUI 700 provides a user interface where the user can input his/her answer via a step-by-step process as shown in the steps to solution 702. For example, in step 1, the GUI 700 monitors the user's selection of one of the operators. As shown in the example of FIG. 7, the user chooses a binary operation 730, for example, a division operator “/” in step 1. Upon detecting the user's selection, the GUI 700 presents an input box 740 for the user to input his/her answer to the binary operation 730. A “submit” button 760 is provided for the user to submit his/her answer for this specific step. A “back” button 770 allows the user to choose to go back one or more steps in order to make corrections before a final answer is submitted.

Upon detecting the user's submit, the GUI 700 display the expression 705 with the input box 740 replaced by the user's input, no matter the user's answer is correct or not. In the following each step, same as that in step 1, the GUI 700 monitors the user's selection of one of the operators, detects the selection, displays an input box, and receives the user's answer to a binary expression of the expression 705, until a single answer representing the user's answer to the expression 705.

The GUI 700 provides a cumulative evaluation of the expression 705 that is determined by rules provided by an order of operation sub-module, such as the order of operation sub-module 622 of FIG. 6.

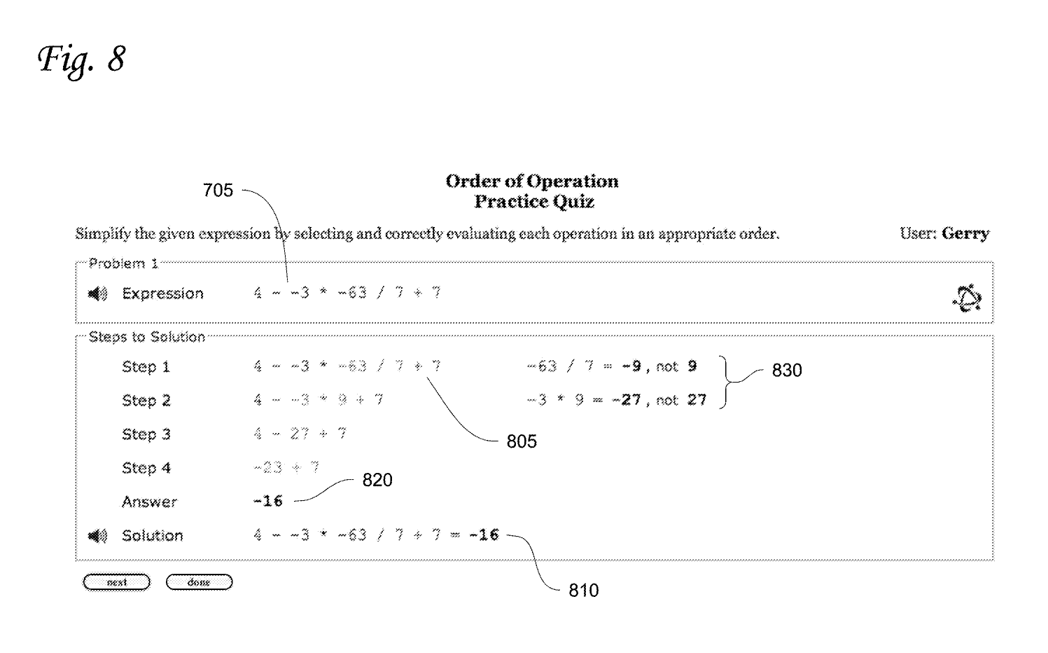

FIG. 8 is an example screenshot of an exemplary automated feedback presented by the GUI 700 for the user upon the completion of the evaluation of the expression 705 of FIG. 7. The user's step-by-step answers to the expression 705 include step 1, step 2, step 3 and step 4. In each step, a respective binary operation within the expression 705 is selected by the user. The GUI 700 provides a step-by-step evaluation 830 of the user's order of operation selection and answers to the resulting binary expressions in the above each step. In some embodiments, the evaluation 830 is shown only if the user's selection and/or answer is incorrect in a specific step. It would be appreciated that an evaluation for the student's selection and answer to a specific step can be displayed upon completion of that specific step.

A final answer 820 from the user to the expression 705 is presented and compared to a standard answer 810. In the illustrated example, the user's final answer 820 to the expression 705 is correct. However, the step-by-step evaluation 830 shows that the user's step-by-step answers to the selected binary operations in each step 1 and step 2 are incorrect.

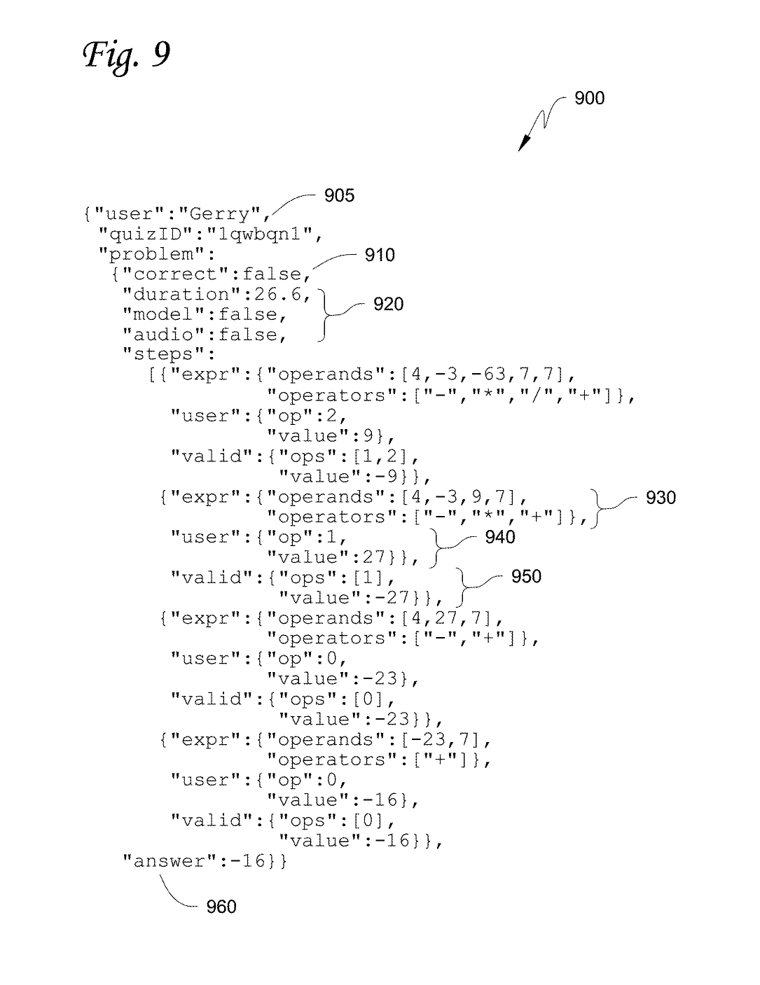

FIG. 9 shows an exemplary JavaScript Object Notation (JSON) coding representing data collected during the evaluation of the user's step-by-step answer to the expression of FIGS. 7 and 8. A region 905 shows the user's identification and a quiz's identification which allow for multiple problems to be presented as a single unit.

The JSON data 900 further include a problem information 910 indicating the user's answer is correct or false. This is not representative of just whether the final answer is in agreement to the standard answer, but includes whether the user made any errors in selection of order of operation or answer to any of the resulting binary expressions in a specific step. For example, the user gave incorrect answers in the step 1 and step 2 of FIG. 8, which results in the problem information 910 to be false although the final answer 820 is correct.

The JSON data 900 further include an additional problem information 920 including, e.g., total duration of time the user spend on the problem and whether the user chose to view the optional visual and audio information. The additional problem information 920 can be used to categorize the type of learning style best suited for a specific user.

For each step, for example, the steps 1, 2, 3 and 4 of FIG. 8, the JSON data 900 includes operands and operators 930 for an expression, such as the expression 705 of FIGS. 8-9. The expression 705 in the steps 2, 3 and 4 results from the user's selection and answer to a specific binary operation in the previous step, which allows an evaluation of the user's performance on each step without a propagation of errors made on previous steps. A “user” section 940 includes data related to the user's selection and answer in a specific step. A “valid” section 950 includes data related to the standard answer in a specific step. An “answer” section 960 includes the final answer from the user.

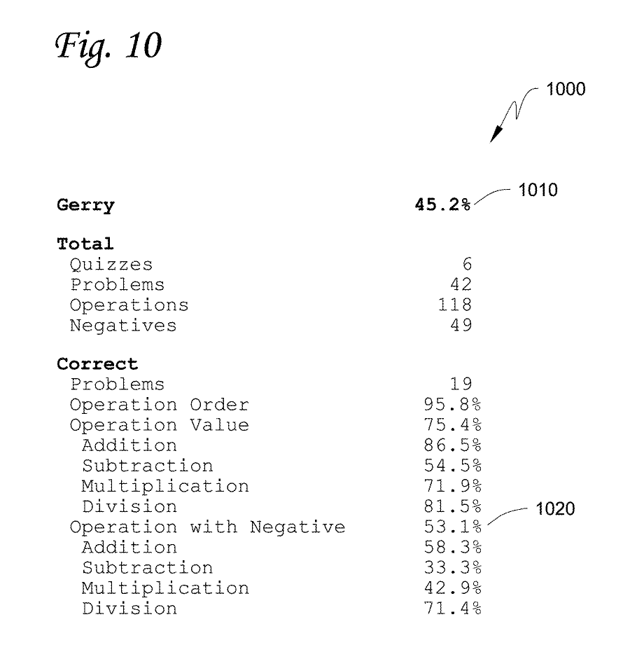

FIG. 10 is an example screenshot illustrating an exemplary accumulative evaluation report of a user's scores over a number of problems based on the order of operation module of FIG. 6. The report 1000 includes an overall percentage of correct answers 1010, which is 45.2% in this example and indicates the user is having difficulties with the concepts covered in an operation module, such as the operation module 600 of FIG. 6. Further inspection reveals a primary difficulty with operations that contain negative numbers, for which the percentage of correct answers 1020 is only 53.1%, significantly lower than the percentages of other skills. Based on this report 1000, the user should be given more exercises based on a negatives sub-module such as the negatives sub-module 1130 of FIG. 6 toward understanding the unary operation to correctly answer mathematical expressions under the rules for order of operation and the skills necessary to perform binary operations correctly.

The invention may be embodied in other forms without departing from the spirit or novel characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A system for optimizing individualized instruction and assessment, the system comprising:
a user base component that contains electronic student record (ESR) data for an individual;
a knowledge base component that contains knowledge management data;
a standards base component that contains curriculum data and criteria data;
a network connecting the user base component, the knowledge base component and the standards base component;
an inference engine module that can access to the ESR data of the user base component, the knowledge management data of the knowledge base component, and the curriculum data and criteria data of the standards base component, and creates an individualized lesson plan for the individual based on the data therein; and
a communication terminal for the individual to interact with the inference engine module.

2. The system of claim 1, wherein the user base component includes an ESR module configured to store and update the ESR data, a translation module configured to transform the ESR data to formatted ESR data which can be processed by the inference engine module with the curriculum data, the criteria data, and the knowledge management data.

3. The system of claim 2, wherein the ESR data include a plurality of individualized student data, including personality data and user base data of the individual.

4. The system of claim 1, wherein the standards base component includes a curriculum module configured to store the curriculum data and a criteria module configured to store the criteria data.

5. The system of claim 1, wherein the inference engine module includes an operation module configured to provide a step-by-step analysis for an individual's answer to a mathematical expression.

6. The system of claim 5, wherein the operation module includes a plurality of sub-modules each associated with a decomposition of a mathematical expression.

7. The system of claim 5, wherein the operation module includes a binary operations sub-module capable of providing basic binary and unary operations and a general expressions sub-module capable of building general expressions based on the basic binary and unary operations and evaluating order of operations for the respective basic binary and unary operations within each general expressions.

8. The system of claim 1, wherein the knowledge base component includes a psychological module, an instructional module, a brainwave module, a language/culture module, and a performance module that store the knowledge management data including psychological data, instructional data, brainwave data, language/culture data, and performance data, respectively.

9. The system of claim 1, wherein the communication terminal includes an input/output module for the individual to send/receive information, a processor module to process the information sent/received via the input/output module, a data storage module capable of storing information, and a network connection module.

10. A method for optimizing individualized instruction and assessment, the method comprising:
monitoring and detecting an individual to login into an individualized instruction and assessment system which includes a user base component, a knowledge base component and a standards base component;
transforming electronic student record (ESR) data for the individual into formatted ESR data;
accessing knowledge management data provided by the knowledge base component and curriculum and criteria data provided by the standards base component, and processing the ESR data with the knowledge management data and the curriculum and criteria data;
determining whether the formatted ESR data is sufficient to create an individualized lesson plan;
if the formatted ESR data is not sufficient, performing an additional assessment on the individual and updating the formatted ESR data until the formatted ESR data is sufficient to create an individualized lesson plan;
if the formatted ESR is sufficient, creating the individualized lesson plan for the individual, including:
determining curriculum and criteria data sets for creating the lesson plan;
accessing the knowledge management data and determining a psychological data set, a brainwave data set, a language/cultural data set, an instruction data set and a performance data set for creating the lesson plan; and
compiling the curriculum and criteria data set, the psychological data sets, the brainwave data set, the language/cultural data set, the instruction data set and the performance data set to create the lesson plan;
and
presenting the individualized lesson plan to the individual.

11. The method of claim 10, wherein the individualized lesson plan includes a brain warm-up section, an instruction section, and an exercises/evaluation section.

12. The method of claim 11, wherein the brain warm-up section includes a warm-up exercise to maximize brainwave activity.

13. The method of claim 11, wherein the instruction section includes a core presentation.

14. The method of claim 11, wherein the exercise/evaluation section includes one or more question and answer drills.

15. A method for providing a graphical user interface to a computer device for an individual to answer one or more questions and to evaluate the individual's answer, the method including:
creating question and answer drills based on state and national academic standards;
displaying on a display of the computer device a first question from the question and answer drills;
monitoring and detecting the individual's answer;
determining whether the individual's answer is correct;
analyzing the individual's incorrect answer, including:
determining whether the incorrect answer is a result of the individual making a wild guess;
sending out an alert to the individual if the individual made the wild guess;
determining one or more causes associated with why the individual could have reached the incorrect answer;
if there are multiple causes, presenting the individual a second question that is configured to narrow down the number of the multiple ways; and
if there is only one cause, recording the cause in a formatted ESR data and providing a step by step tutorial to the individual based on the cause;
producing an assessment report and displaying the report on the display.

16. A method for providing a graphical user interface to a computer device for an individual to exercise a plurality of mathematical expressions including a first mathematical expression step by step and to evaluate the individual's performance, the method including:
displaying on a display of the computer device the mathematical expression;
monitoring and detecting for selection of a first operator associated with a first operation in the first mathematical expression;
after detecting the selection of the first operator, displaying on the display of the computer device an input box for the individual to input an answer to the first operation;
monitoring and detection for the individual's input;
displaying an updated mathematical expression with the first operation of the first mathematical expression replaced by the individual's input;
after detecting a final answer for the mathematical expression, evaluating the individual's selection of the first operator and evaluating the individual's answer to the selected first operation; and
displaying a result associated with the evaluations on the display of the computer device.

17. The method of claim 16, further comprising displaying an audio option adjacent the expression configured to allow the individual to choose to hear an audio recording of the expression and associated information.

18. The method of claim 16, further comprising displaying a model option adjacent the expression configured to allow the individual to choose to view the expression in a pictorial, video or model format, and associated information.

19. The method of claim 16, further comprising displaying an accumulative evaluation report.

20. The method of claim 19, further comprising creating and displaying an additional mathematical expression based on the accumulative evaluation report for the individual to exercise.
